(19) United States
(12) Patent Application Publication
(10) Pub. No.: US 2006/0013446 A1
(43) Pub. Date: Jan. 19, 2006

(54) Mobile communication device with real-time biometric identification

(76) Inventor: Debra K. Stephens, Cary, NC (US)

Correspondence Address: COATS & BENNETT/SONY ERICSSON, 1400 CRESCENT GREEN, SUITE 300, CARY, NC, 27511, US

(21) Appl. No.: 10/893,456

(22) Filed: Jul. 16, 2004

(51) Int. Cl. G06K 9/00

(52) U.S. Cl. 382/115

(57) ABSTRACT

A personal information management device includes a memory for storing a personal information management database containing contact information pertaining to personal contacts of the user. The contact information includes identification data identifying one or more personal contacts and biometric signatures of the contacts. A biometric sensor discreetly captures biometric data, such as an image or voiceprint, of a person encountered in business or social meetings for identification. A biometric processor compares the captured biometric data to the stored the biometric signatures in the contact database to identify the person, the person's characteristics, or personal information. Identification data for matching contacts is output to a display or other output device to assist or prompt the user's recollection of the person's identity or other information.

### BACKGROUND OF THE INVENTION

The present invention relates generally to personal information (PIM) management devices and more particularly to PIM devices capable of real-time biometric identification.

Personal information management (PIM) devices enable users to store information about personal contacts in a convenient and readily accessible form. PIM devices often incorporate calendaring applications to assist users in keeping track of events and task lists to remind users of tasks that need to be done. Examples of PIM devices include personal digital assistants, such as the PALM PILOT, and laptop computers. Wireless communication devices, such as cellular telephones, often have PIM features for storing contact information, telephone numbers and other information and are therefore also considered PIM devices as that term is used herein.

It is not uncommon in business and social settings for people to forget the names of persons with whom they have interacted in the past. Such forgetfulness may sometimes be merely annoying, but in other situations may be embarrassing. While personal information management devices may assist the user in recalling useful information about a person, it is of little use in helping the user remember the name of a person that is beyond the user's present recollection.

### SUMMARY OF THE INVENTION

A personal information management device is provided to assist the user in recalling the names of persons encountered in business and social settings. The personal information management device comprises a portable unit having a memory for storing a contact database. The contact database stores identification data identifying one or more personal contacts, and other information pertaining to the contact, such as addresses, telephone numbers, spouse's and children's names, job titles, and other information. In a preferred embodiment, the contact database also stores biometric signatures correlated with the identification data. The biometric signatures could, alternatively, be stored in a server in a remote network.

When the user encounters a person in a business or social setting that the user knows but whose name the user cannot recall, the portable unit may be used to discreetly identify the person. A biometric sensor in the portable unit captures biometric data from the person to be identified. A biometric processor located either in the portable unit or the remote server compares biometric signatures derived from the captured biometric data to stored biometric signatures correlated with the identification data in the contact database. An output device in the portable unit outputs identification data extracted from the contact database based on the comparison of the captured biometric data to the stored biometric signatures. In preferred embodiments, the identification data is output to a display on the portable unit.

### BRIEF DESCRIPTION OF THE DRAWINGS

FIG. 1 is a block diagram of an exemplary PIM device according to the present invention.

FIG. 2 is perspective view from the front of the exemplary PIM device.

FIG. 3 is a perspective view from the back of the exemplary PIM device.

FIG. 4 is a schematic diagram illustrating the biometric identification process.

FIG. 5 is a flow chart illustrating a process for biometric identification using face recognition.

FIG. 6 is a flow chart illustrating a process for biometric identification using voice recognition.

FIG. 7 is a perspective view illustrating an alternate embodiment of the PIM device.

FIG. 8 is a block diagram illustrating an alternate embodiment of the present invention wherein the portable PIM device comprises a main unit and a remote unit.

FIG. 9 is a perspective view illustrating an embodiment of the present invention according to the block diagram of FIG. 8.

FIG. 10 is a perspective view illustrating another embodiment of the present invention according to the block diagram of FIG. 8.

FIG. 11 is a schematic diagram illustrating an alternate embodiment of the invention with the biometric processor located in a remote server.

### DETAILED DESCRIPTION OF THE INVENTION

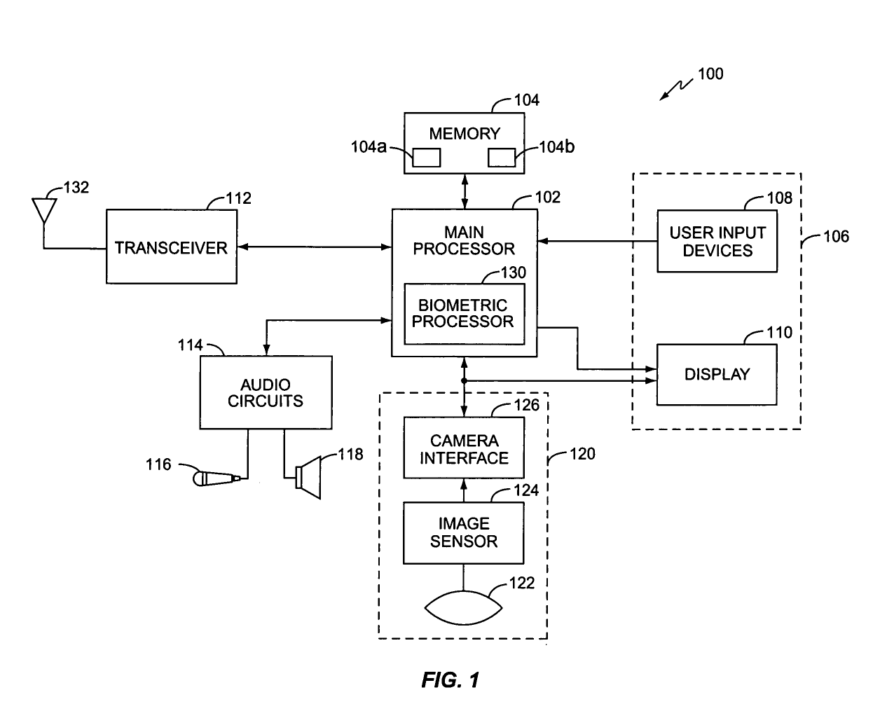

FIG. 1 is a block diagram of an exemplary personal information management (PIM) device 100 according to the present invention. The exemplary PIM device 100 is a multi-function device that combines a personal digital assistant (PDA), wireless transceiver, and camera into the same physical package. The exemplary embodiment is for illustrative purposes only and is not intended to limit the scope of the invention. Other embodiments will be readily apparent to those skilled in the art. The exemplary PIM device 100 comprises one or more system processors 102, memory 104, a user interface 106, a wireless transceiver 112, audio circuits 114, a microphone 116, a speaker 118, and a camera assembly 120.

System processor 102 performs various processing tasks including control the overall operation of the PIM device 100 according to programs stored in memory 104. The system processor 102 may be implemented in hardware, firmware, software, or a combination thereof. The system processor 102 may comprise a single microprocessor or multiple microprocessors. The microprocessors may be general purpose microprocessors, digital signal processors, or other special purpose processors. The functions performed by the system processor 102 include audio processing, image processing, and control of the overall operation of the PIM device 100. As discussed in greater detail below, the signal processor 102 includes a biometric processor 130 to perform biometric identification of individuals.

Memory 104 may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with system processor 102. For example, memory 104 may store a personal information management application 104a and/or a contact database 104b to perform personal information management tasks for the user, as will be described below in more detail.

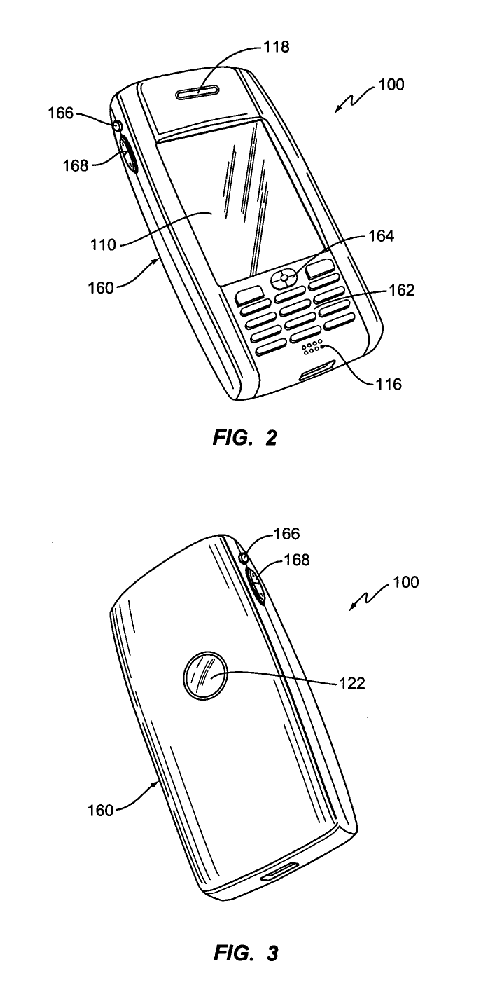

The user interface 106 includes one or more user input devices 108 and a display 110. User interface 106 enables the user to interact with and control the PIM device 100. The user input devices 108 may include any of a keypad, touchpad, joystick control dials, control buttons, other input devices, or a combination thereof. A voice recognition system may also be used to receive user voice input. An exemplary user interface 106, illustrated in FIG. 2, includes an alphanumeric keypad 162 and a joystick control 164 as is well known in the art. Keypad 162 and joystick control 164 allow the operator to dial numbers, enter commands, scroll through menus and menu items presented to the user on display 110, and make selections. Display 110 allows the operator to view information such as menus and menu items, dialed digits, images, call status information, and output from user applications.

Transceiver 112 is coupled to antenna 132 for receiving and transmitting signals. Transceiver 112 is a fully functional cellular radio transceiver, which may operate according to any known standard, including the standards known generally as the Global System for Mobile Communications (GSM), TIA/EIA-136, cdmaOne, cdma2000, UMTS, and Wideband CDMA. Transceiver 112 preferably includes baseband processing circuits to process signals transmitted and received by the transceiver 112. Alternatively, the baseband processing circuits may be incorporated in the system processor 102.

Audio circuits 114 receive analog audio inputs from microphone 116 and provide basic analog output signals to speaker 118. Microphone 116 converts the detected speech and other audible signals into electrical audio signals and speaker 118 converts analog audio signals into audible signals that can be heard by the user.

Camera assembly 120 includes lens assembly 122, image sensor 124, and camera interface circuits 126. Camera assembly 120 may also optionally include image processing circuits for performing some image processing tasks. Camera assembly 120 may be a digital still camera or a video camera. Lens assembly 122, comprising a single lens or a plurality of lenses, collects and focuses light onto image sensor 124. Image sensor 124 captures images formed by light collected and focused by lens assembly 122. Image sensor 124 may be any conventional image sensor 124, such as a charge-coupled device (CCD) or a complementary metal oxide semiconductor (CMOS) image sensor. Camera interface circuits 126 convert analog image signals output by image sensor to digital form and interface the image sensor 124 with the system processor 102. As shown in FIG. 1, camera assembly 120 may output image signals directly to display 110 to enable use of the display 110 when the PIM device 100 is operated in a camera mode.

FIGS. 2 and 3 illustrate the physical appearance of an exemplary PIM device 100. The PIM device 100 includes a housing 160 containing the elements shown in FIG. 1. A keypad 162, joystick control 164, display 110, microphone 116, and speaker 118 are disposed on the front of housing 160 as seen best in FIG. 2. The keypad 162 and joystick control 164 serve as user input devices 108. The camera lens 122 is disposed in the back of the housing 160 as seen in FIG. 3, or some other location that allows visual images to be discreetly acquired. Control buttons 166 and 168 are disposed on the side of the housing to control operation of the camera assembly 120. Control button 166 functions as a shutter control and control button 168 functions as a zoom control when the PIM device 100 is in a camera mode. Because PIM device 100 may be a multi-function device, different functions may be assigned to control buttons 166 and 168 in other modes of operation.

Memory 104 stores a personal information management (PIM) application 104a and a contact database 104b to perform personal information management tasks for the user. The personal information management application 104a allows the user to store and manage contact information for subsequent retrieval and use. The personal information management application 104a may cooperate or interact with other applications. Alternatively, the PIM application 104a may be part of a larger application that performs other functions in addition to contact management. Contact information stored in the contact database 104b includes identification data associated with the contact, such as the contact's name, and other contact information such as addresses, telephone numbers, email addresses, web page addresses, images, names of spouses and children, and other personal data. Additionally, the contact database 104b may include biometric signatures correlated with the identification data for use in identification of persons during normal social or business interactions. The biometric data could alternatively be stored in a remote server accessible to the PIM device 100. The biometric signatures may, for example, comprise voiceprints for voice identification and/or face templates for face recognition.

Stored biometric signatures may be acquired in a number of ways. Images or voice samples of a person may be downloaded to the PIM device 100 from a remote computer through an interface such as an USB interface, Ethernet interface, infrared interface, or short-range wireless interface (e.g., a Bluetooth interface). Images and voice samples may also be received over a wireless communication network via transceiver 112. Images and voice samples could be included as electronic business cards, commonly known as V-cards. Images and voice samples may also be acquired using the internal camera 120 and microphone 116. The acquired images and voice samples may then be processed by biometric processor 130 to generate biometric signatures that can be associated with individual contacts in the contacts database 104b. Techniques for generating biometric signatures are well known in the art and are not described in detail herein.

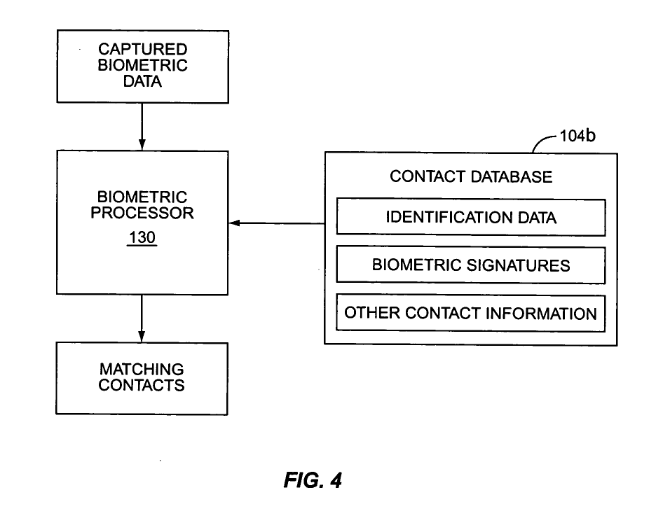

The biometric signatures stored in memory 104 may be used to identify individuals in social or business settings. When a person encountered in a business or social setting is known to the user of the PIM device 100, but whose name the user has forgotten, the user may activate a biometric identification process using the PIM device 100 to identify the individual. The user may activate the biometric identification process via user interface 106, such as by making a menu selection or pressing a predetermined button or sequence of buttons on keypad 162. FIG. 4 schematically illustrates a biometric identification process. Biometric data is acquired from the individual and input to a biometric processor 130. Biometric data may, for example, be a visual image captured by camera 120 or a voice sample captured by microphone 116. The biometric processor 130 generates a biometric signature from the captured biometric data that is compared to stored biometric signatures stored in the contact database 104b or on a remote server. If a match is found, the biometric processor 130, in cooperation with the PIM application 104a outputs identification data of one or more matching individuals to prompt the user's recollection. It may not be necessary to narrow the field of individuals stored in the contact database 104b to a single individual. If the field of candidates can be narrowed to a small list of individuals, the identification data may refresh the user's recollection, thereby enabling the user to confirm the identity of the individual.

There are numerous biometric identification techniques suitable for implementation in a PIM device 100. The least intrusive and most readily acceptable forms of biometric identification are face recognition and voice recognition. Visual images of a person for biometric identification may be readily obtained using the built-in digital camera 120. Voice samples for voice recognition may be obtained using the built-in microphone 116. Other forms of biometric identification include iris and retinal scanning, fingerprinting, and hand geometry.

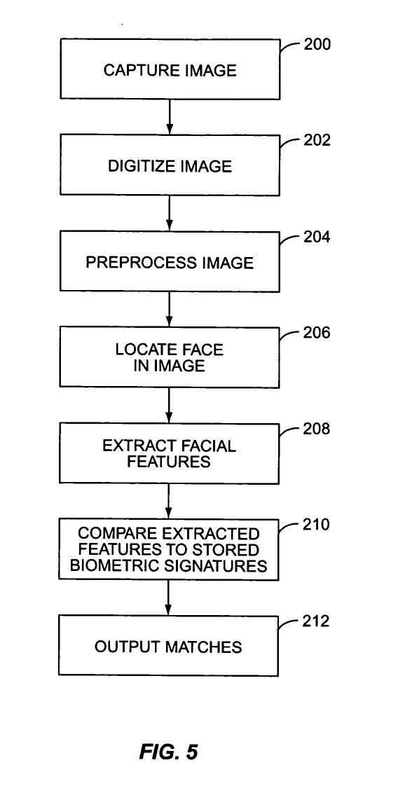

FIG. 5 is a flow diagram illustrating a method of biometric identification using face recognition. When the user encounters an individual in a social or business setting whose name the user cannot recall, the user captures a visual image of the individual using the built-in digital camera 120 (block 200). The captured image is digitized (block 202) to generate a digital representation of the image. Analog-to-digital conversion is performed by the camera interface circuit 126. The digital image is pre-processed (block 204) in an image processor within the system processor 102 to prepare the image for biometric identification. Some pre-processing of the image may be performed by image processing circuits in camera assembly 120 if the camera assembly 120 has image processing capabilities. Pre-processing may include, for example, color correction, and adjustments to darkness and contrast. The purpose of the pre-processing is to generate a clean image to improve the accuracy of the biometric identification. From the pre-processed image, the biometric identification processor 130 locates the subject's face within the image (block 206) and extracts facial features (block 208) that serve as a biometric signature. The biometric processor 130 compares the extracted facial features with the biometric signatures stored in memory to determine if a match exists (block 210). There are many known approaches to face recognition ranging from the Principal Component Analysis (PCA) approach (also known as eigenfaces), Elastic Graph Matching (EGM), Artificial Neural Networks, to pseudo-2D Hidden Markov Models (HMM). The biometric processor 130 may need to normalize the image prior to comparison with the stored biometric signatures. The comparison algorithm may generate a score that ranks those biometric signatures stored in memory that best match the biometric signature extracted from the captured image. The list of matches and rankings may be supplied by the biometric processor 130 to the PIM application 104a for output to the user (block 212).

Because the number of individuals in a contact database is typically not very large, known biometric identification processes may be modified to improve speed. For example, smaller feature sets may be used for identification to speed processing. Using a smaller feature set may reduce accuracy of identification but will likely be sufficient for prompting a user's recollection. As noted above, if the biometric processor 130 can narrow the field of candidates to a small number, the user will likely recall which person from a list of matching persons is the correct person.

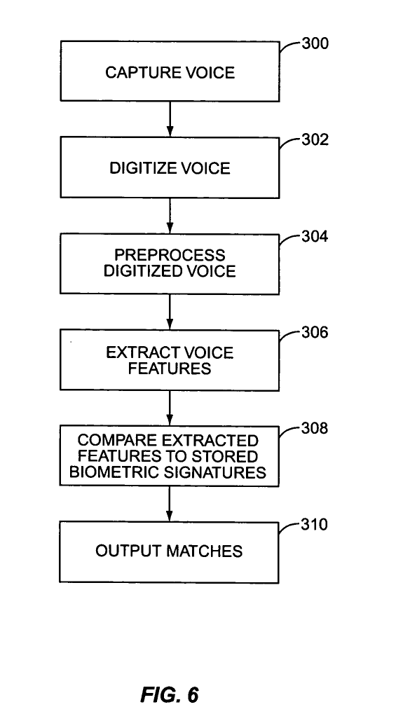

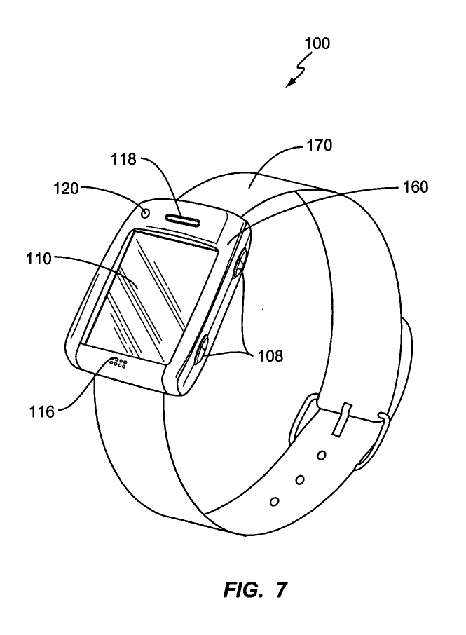

FIG. 6 illustrates a similar method of biometric identification using voice recognition. First, a voice sample from the individual to be identified is captured (block 300) and digitized (block 302). The digitized voice signal is pre-processed by system processor 102 to eliminate noise, artifacts, and unwanted components from the voice signal (block 304). The biometric processor 130 extracts voice features from the voice signal (block 306), which serve as a biometric signature. The extracted voice features are compared to the biometric signatures stored in memory (block 308) by the biometric processor 130. Preferably, the voice recognition technique is text-independent, since the biometric identification feature will likely be used without the subject's knowledge. Methods commonly used for text independent voice recognition include the average spectrum-based methods, VQ-based methods, and the multi-variant auto-regression (MAR) model. If a match is found, the biometric processor 130 in cooperation with the PIM application 104a outputs identification data corresponding to the matching contacts to the user (block 310).

FIG. 7 illustrates an alternate embodiment of the present invention wherein the PIM device 100 is worn by or secured to the user's arm. In this embodiment, the PIM device 100 could have the appearance of a watch, bracelet, wristband, or other device that is worn around the user's arm. The PIM device 100 includes a housing 160 containing the functional elements shown in FIG. 1, and a wristband 170 for securing the device 100 to the user's arm. Display 110 on the face of the PIM device 100 displays identification data to the user, while microphone 116 and camera 120 permit the user to discreetly capture biometric data for comparison with biometric signatures stored in memory 104. Speaker 118 outputs audible signals and, in combination with microphone 116, permits two-way voice communication with a remote device. The user input 108 in this embodiment comprises one or more push buttons on the housing 160 that enable the user to control the PIM device 100. Although not specifically shown, a battery may be disposed in housing 160 to supply power to PIM device 100. The PIM device 100 is secured to the user's wrist by a wristband 170.

The embodiments of the invention shown in FIGS. 1-7 comprise a portable device constructed with all the components forming a part of a unitary structure. However, those skilled in the art will appreciate that the portable device may comprise two or more separate units that cooperate with each other to acquire, compare, and display biometric data.

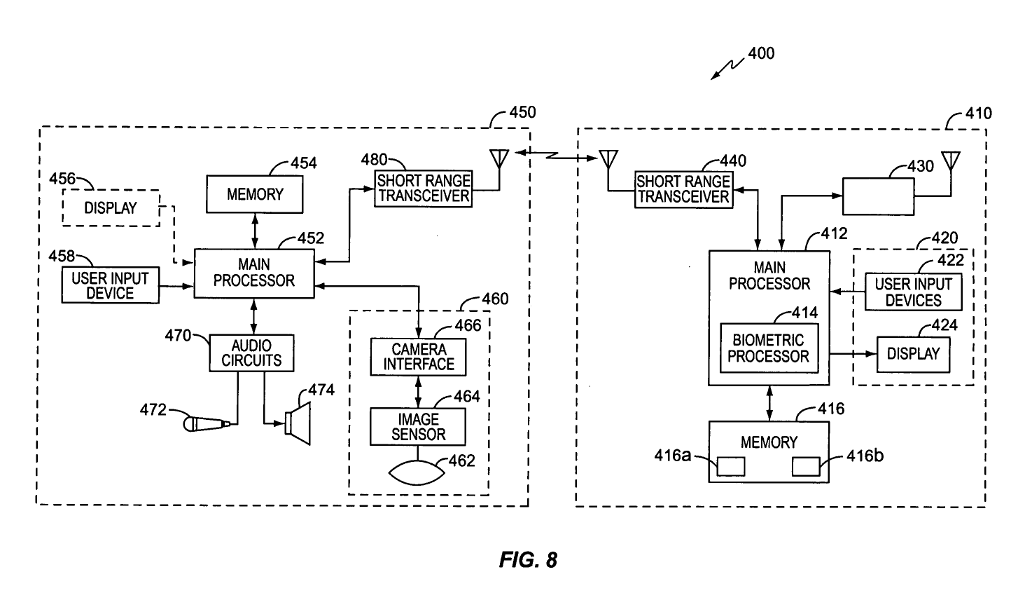

FIG. 8 is a block diagram illustrating a PIM device 400 comprising a main unit 410 and a remote unit 450. The main unit 410 comprises a system processor 412, memory 416, user interface 420, long-range transceiver 430, and short-range transceiver 440. The system processor 412 controls the overall operation of the device 400 according to instructions stored in memory 416. System processor 412 includes a biometric processor 414. Memory 416 stores computer programs and data necessary for operation of the PIM device 400, including a personal information management application 416a and contact database 416b. User interface 420 includes a user input device 422, such as a keypad, and a display 424. Long-range transceiver 430 may comprise a cellular radio transceiver operating according to any known standards, such as the TIA/EIA-136, GSM, or cmda2000 standards. The short-range transceiver 440 is preferably a short range wireless transceive for communicating with the remote unit 450. Short-range transceiver 440 may, for example, comprise a Bluetooth transceiver, or a transceiver operating according to the IEEE 802.11(b) standard.

The remote unit 450 comprises a system processor 452, memory 454, camera assembly 460, audio processing circuit 470, and user input device 458. System processor 452 controls the operation of the remote unit 450. Memory 454 stores program instructions and data necessary for operation of the remote unit 450. User input device 458 comprises push buttons or other controls for controlling the remote unit 450. Camera assembly 460 includes lens assembly 462, image sensor 464, and camera interface circuits 466. The lens assembly 462 may comprise a single lens or a plurality of lenses. The lens assembly 462 collects and focuses light onto image sensor 464, which captures images formed by light on the image sensor 464. Image sensor 464 may be any conventional image sensor, such as a charge-coupled device (CCD) or a complimentary metal oxide semiconductor (CMOS) image sensor. Camera interface circuits 466 convert analog image signals output by image senor 464 to digital form and interface the image sensor 464 with the system processor 452. Audio circuits 470 receive analog audio inputs from microphone 472 and provide basic analog output signals to speaker 474. Microphone 472 converts detected speech and other audible signals into electrical audio signals and speaker 474 converts analog audio signals into audible signals that could be heard by the user. Short-range transceiver 480 preferably comprises some type of wireless transceiver for communicating with the main unit 410. The short-range transceiver 480 may comprise a Bluetooth transceiver or a transceiver operating according to IEEE 802.11(b) standard.

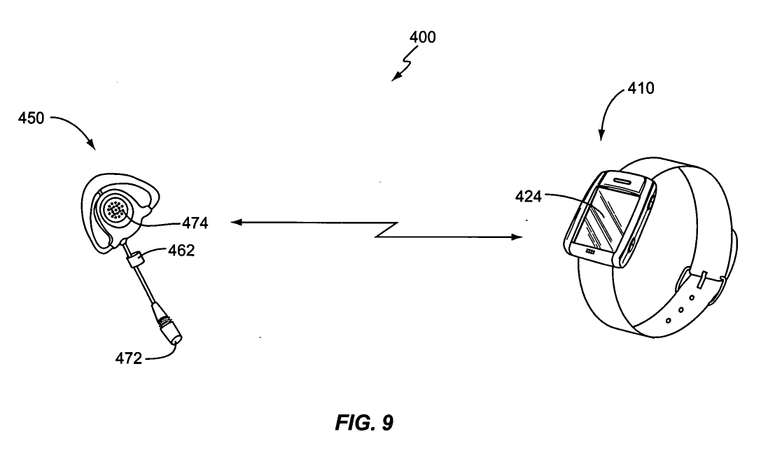

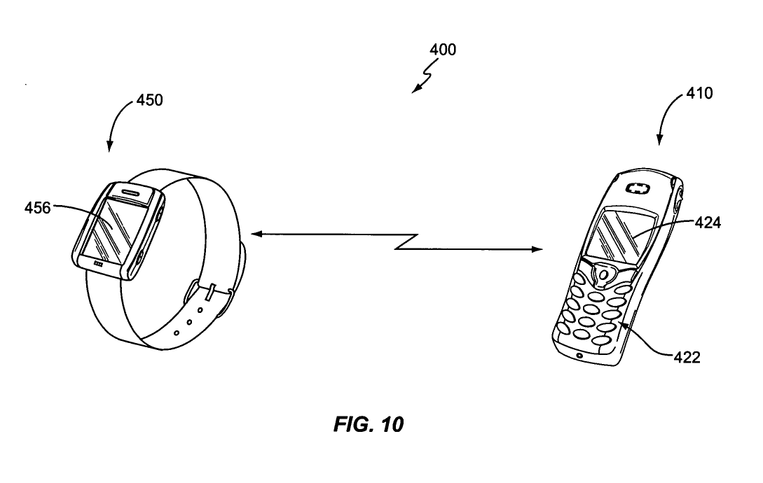

FIGS. 9 and 10 illustrate possible physical appearances of the PIM device 400 shown in FIG. 8. In the embodiment shown in FIG. 9, the main unit 410 resembles a watch and can be worn on the arm of a user. The remote unit 450 comprises a wireless headset 450. In the embodiment shown in FIG. 10, the main unit 410 comprises a hand-held device, such as a personal digital assistant (PDA) or cellular telephone and a remote unit 450 containing a display 456 is worn on the user's arm.

In operation, the remote unit 450 captures and sends biometric data to the main unit 410 via short-range transceivers 480, 440. The main unit 410 processes the biometric data as previously described and outputs identification data to the display 424. While the display is shown on the main unit 410 in FIGS. 8-10, those skilled in the art will appreciate that a display 456 could also be located on the remote unit 450. In such case, the identification data may be sent by the main unit 410 to the remote unit 450 via short-range transceivers 440, 480.

Identification of individuals based on multiple biometrics is an emerging trend. The present invention may employ multi-mode biometric identification techniques that combine face recognition and voice recognition in making a personal identification. Multi-mode identification takes advantage of the capabilities of each individual biometric and can be used to overcome limitations of a single biometric.

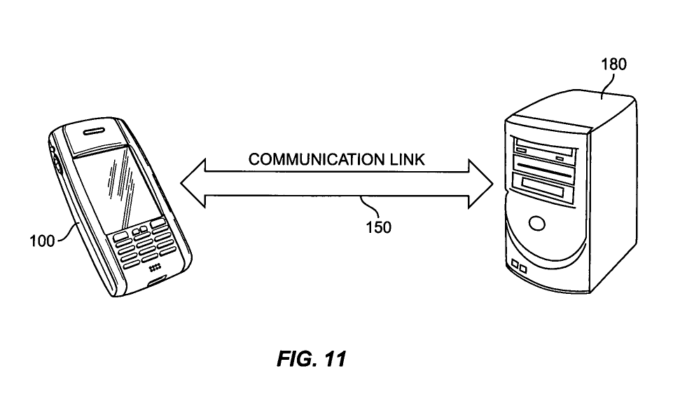

In other embodiments, the memory for storing biometric signatures and the biometric processor 130 may be located in a remote server within a network accessible to the PIM device 100. As shown in FIG. 11, the PIM device 100 may communicate via a communications link 150 with a server 180 in a remote network. The remote server 180 may, for example, be accessible via a public land mobile network. In this case, the transceiver 112 may comprise a conventional cellular radio transceiver for communicating with the public land mobile network. The PIM device 100 could also contain other types of interfaces to connect to the remote server 180. Interfaces suitable for use in the present invention include short-range wireless interfaces, such as a Bluetooth interface or 802.11(b) compliant interface, an infrared interface, a serial interface, or a USB interface.

The present invention enables a user to discreetly acquire biometric data, such as a visual image or a voice sample, for comparison with stored biometric signatures as an aid in identifying an individual in business or social settings. The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A personal information management system comprising:
a. a portable unit;
b. memory in the portable unit for storing a contact database including identification data identifying one or more personal contacts;
c. a biometric sensor in the portable unit to capture biometric data from a person to be identified;
d. a biometric processor to compare the captured biometric data to stored biometric signatures correlated with the identification data in the contact database; and
e. an output device in the portable unit to output identification data extracted from the contact database based on the comparison of the captured biometric data to the stored biometric signatures.

2. The personal information management device of claim 1 wherein the biometric processor is located in the portable unit.

3. The personal information management device of claim 2 wherein the biometric signatures are stored in the contact database in the portable unit.

4. The personal information management device of claim 1 wherein the biometric processor is located in a remote server.

5. The personal information management device of claim 4 further comprising a wireless transceiver for communicating with the remote server.

6. The personal information management device of claim 1 wherein the biometric sensor is a camera for acquiring a visual image, and wherein the biometric processor processes the visual image to generate a biometric signature for comparison to the stored biometric signatures.

7. The personal information management device of claim 1 wherein the biometric sensor is a microphone for acquiring a voiceprint, and wherein the biometric processor processes the voiceprint to generate a biometric signature for comparison to the stored biometric signatures.

8. The personal information management device of claim 1 wherein the output device is a display.

9. The personal information management device of claim 1 wherein the portable unit comprises a main unit and a remote unit.

10. The personal information management device of claim 9 wherein the biometric sensor is integrated with the remote unit, and the biometric processor is integrated with the main unit.

11. The personal information management device of claim 9 wherein the biometric processor is integrated with the main unit and the output device is integrated with the remote unit.

12. The personal information management device of claim 9 wherein the main unit and remote unit each include a transceiver to communicate with each other over a communications channel.

13. The personal information management device of claim 9 wherein the remote unit comprises a hands-free headset, and the main unit comprises a hand-held device.

14. The personal information management device of claim 13 wherein the main unit comprises a personal digital assistant.

15. The personal information management device of claim 13 wherein the main unit comprises a cellular telephone.

16. The personal information management device of claim 1 wherein the portable device comprises a single self-contained unit.

17. The personal information management device of claim 16 wherein the portable unit comprises a personal digital assistant.

18. The personal information management device of claim 16 wherein the portable unit comprises a cellular telephone.

19. A method of using a portable PIM device to identify a person, comprising:
a. storing a contact database including identification data identifying one or more personal contacts in a memory of a portable PIM device;
b. capturing biometric data from a person to be identified with a biometric sensor located in the portable PIM device;
c. comparing the captured biometric data to stored biometric signatures correlated with the identification data in the contact database; and
d. outputting to an output device located in the portable PIM device identification data extracted from the contact database based on the comparison of the captured biometric data to the stored biometric signatures.

20. The method of claim 19 wherein comparing the captured biometric data to stored biometric signatures is performed by a biometric processor located in the portable PIM device.

21. The method of claim 20 further comprising storing the biometric signatures in the contact database in the portable PIM device.

22. The method of claim 19 wherein comparing the captured biometric data to stored biometric signatures is performed by a biometric processor located in a remote server accessible to the portable PIM device.

23. The method of claim 22 further comprising communicating the biometric data to the remote server and receiving comparison results from the remote server.

24. The method of claim 19 wherein capturing biometric data from a person to be identified comprises acquiring a visual image with a camera located in the portable PIM device.

25. The method of claim 19 wherein capturing biometric data from a person to be identified comprises acquiring a voice sample with a microphone located in the portable PIM device.

26. The method of claim 19 wherein outputting identification data extracted from the contact database comprises displaying selected identification data on a display.

27. The method of claim 19 wherein the portable PIM device comprises a main unit including the biometric processor and a remote unit including the biometric sensor, and wherein biometric data from a person to be identified is captured by said remote unit and transmitted to said main unit.

28. The method of claim 19 wherein the portable PIM device comprises a main unit including the biometric processor and a remote unit including the output device, and wherein identification data output by said biometric processor is transmitted to said remote unit for output by said output device.

29. The method of claim 28 wherein the portable PIM device comprises a single self-contained unit including biometric sensor, biometric processor and output device.

30. A personal information management device comprising:
a. a portable unit;
b. memory in the portable unit for storing a contact database including identification data identifying one or more personal contacts and correlated biometric signatures of said contacts;
c. a biometric sensor in the portable unit to capture biometric data from a person to be identified;
d. a biometric processor in the portable unit to compare the captured biometric data to the stored biometric signatures; and
e. an output device in the portable unit to output identification data extracted from the contact database based on the comparison of the captured biometric data to the stored biometric signatures.

31. The personal information management device of claim 30 further comprising a wireless transceiver in the portable unit.

32. The personal information management device of claim 30 wherein the biometric sensor is a camera for acquiring a visual image, and wherein the biometric processor processes the visual image to generate a biometric signature for comparison to the stored biometric signatures.

33. The personal information management device of claim 30 wherein the biometric sensor is a microphone for acquiring a voiceprint, and wherein the biometric processor processes the voiceprint to generate a biometric signature for comparison to the stored biometric signatures.

34. The personal information management device of claim 30 wherein the output device is a display.

35. The personal information management device of claim 30 wherein the personal information management device comprises a main unit and a remote unit.

36. The personal information management device of claim 35 wherein the biometric sensor is integrated with the remote unit, and the biometric processor is integrated with the main unit.

37. The personal information management device of claim 35 wherein the output device is integrated with the remote unit, and the biometric processor is integrated with the main unit.

38. The personal information management device of claim 35 wherein the main unit comprises a hand-held device and wherein the remote unit comprises a hands-free headset operable with the hand-held device.

39. The personal information management device of claim 35 further comprising a housing containing the memory, biometric processor, biometric sensor and output device.
